(19) United States
(12) Patent Application Publication
(10) Pub. No.: US 2008/0278595 A1
(43) Pub. Date: Nov. 13, 2008

(54) Video Data Capture and Streaming

(75) Inventors: Michael L. Schmit, Cupertino, CA (US); Carrell Daniel Killebrew, Saratoga, CA (US); Shivashankar Gurumurthy, Santa Clara, CA (US)

Correspondence Address: COURTNEY STANIFORD & GREGORY LLP, P.O. BOX 9686, SAN JOSE, CA, 95157, US

(73) Assignee: Advance Micro Devices, Inc., Sunnyvale, CA (US)

(21) Appl. No.: 11/960,640

(22) Filed: Dec. 19, 2007

Related U.S. Application Data
(60) Provisional application No. 60/928,799, filed on May 11, 2007.

(51) Int. Cl. H04N 5/228

(52) U.S. Cl. 348/222.1; 348/E05.031

(57) ABSTRACT

Embodiments of the video data capture and stream method comprise intercepting a flip function call comprising a call by the video application to flip frames between a display and a buffer, grabbing a copy of the current frame that would normally be processed by a central processing unit (CPU), placing the copy in a queue for processing by a graphics processing unit (GPU), wherein processing by the GPU is significantly faster than processing by the CPU.

### RELATED APPLICATIONS

This application claims the benefit of U.S. Provisional Patent Application No. 60/928,799, filed May 11, 2007.

### TECHNICAL FIELD

The invention is in the field of encoding video data.

### BACKGROUND

Video encoders are designed to output a steam of information that is compliant with a particular video compression standard (such as VC-1, H.264, MPEG-2, and others). The way in which the output stream is produced is not dictated by any standard. Therefore, video encoders have been continually refined to produce high quality results with low overhead (for example, low bit-rate) within the constraints imposed available by hardware and software tools. However, current video encoders are not capable of performing some functions, such as encoding a video efficiently enough to allow the video to be streamed in near real time. There are a variety of screen capture applications in existence. The traditional way to perform screen capture is by “grabbing” frames from the screen (video) buffer based on a periodic timer interrupt, but this merely captures one screen at a time and is not fast enough to allow streaming of captured video.

### BRIEF DESCRIPTION OF THE DRAWINGS

FIG. 1 is a block diagram of video capture and stream system according to an embodiment.

FIG. 2 is a flow diagram of a process for capturing video data to be streamed according to an embodiment.

FIG. 3 is a block diagram illustrating code flow before the intercepting code has been installed or substituted for the normal code according to an embodiment.

FIG. 4 is a block diagram illustrating code flow after the intercepting code has been installed or substituted for the normal code.

The drawings represent aspects of various embodiments for the purpose of disclosing the invention as claimed, but are not intended to be limiting in any way.

### DETAILED DESCRIPTION

Embodiments of a method and system for video encoding include a method that takes advantage of massively parallel computing available in graphics processing units. In an embodiment, screen images are captured from a 3D graphics memory, encoded with a video codec, such as MPEG-2 or H.264, and streamed over a network to another video playback device. This allows a system loaded with a powerful CPU and GPU to do the large compute task and a simpler lower cost device do the playback. For example, one high end system could serve one of many low cost decoders/display units.

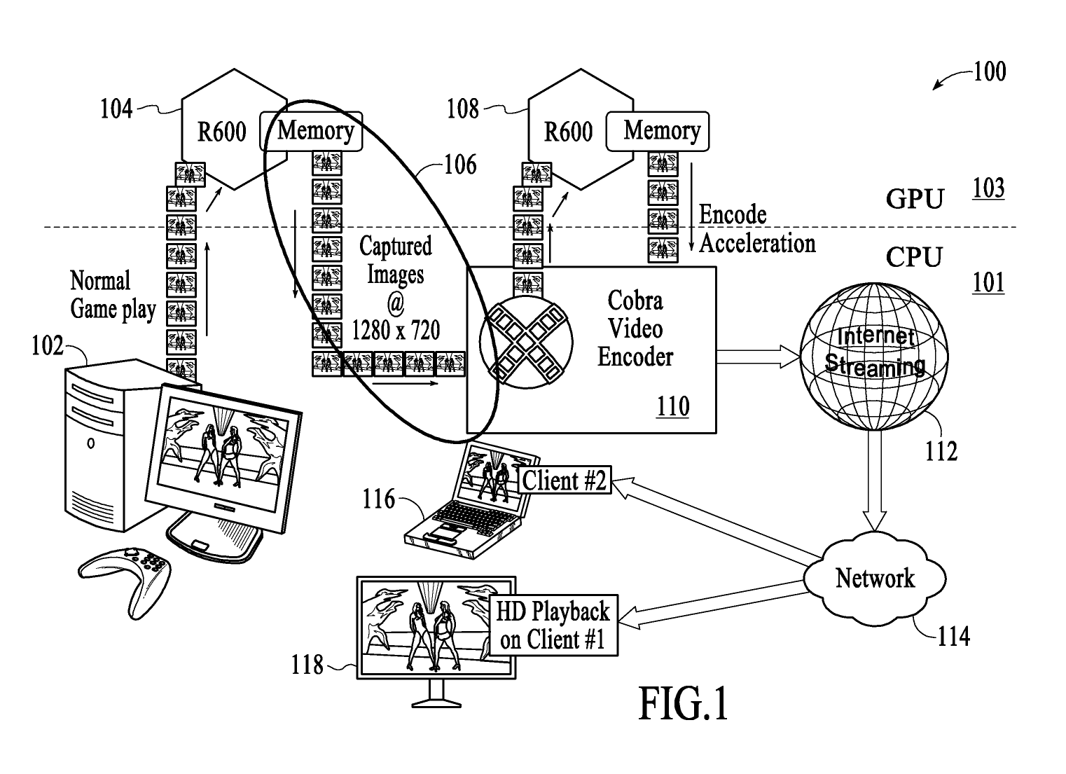

FIG. 1 is a block diagram of a video capture and stream system 100 according to an embodiment. The system 100 includes a central processing unit (CPU) portion 1001 and a graphics processing unit (GPU) portion 103. A video source 102 supplies video data to a GPU 104. The video source can be a 3D video game, or any other application as normally run on a machine such as a personal computer (PC). In another case, the source of the video is from the GPU itself. For example, a user could be playing a 3D game. An application works in the background to grab copies of what is seen on the screen at some periodic interval (such as 30 times per second) and then uses the same GPU or an additional GPU to assist the CPU in encoding it to MPEG-2, (or 11.264 or any other codec) and save it to a file and/or stream it out over the network.

In the area denoted by circle 106, an embodiment replaces dynamic linked library (DLL) functions that the application would normally call in the video driver with predetermined novel functions. In this way, each call is intercepted when the application is flipping between two buffers. The application is typically filling buffer B while the display is showing a buffer A (sometimes also referred to as flipping or switching between a front or first buffer and a back or second buffer, also known as double buffering). When buffer B is ready, a “flip” function is called, thus switching between the two buffers. In an embodiment, the flip call is intercepted, which provides information on exactly when new data is ready.

The captured images are processed by a video encoder 110 and another GPU 108. The result is accelerated encoding that allows the video to be streamed to the Internet 112, and/or any other network 114, and eventually to multiple clients such as clients 116 and 118.

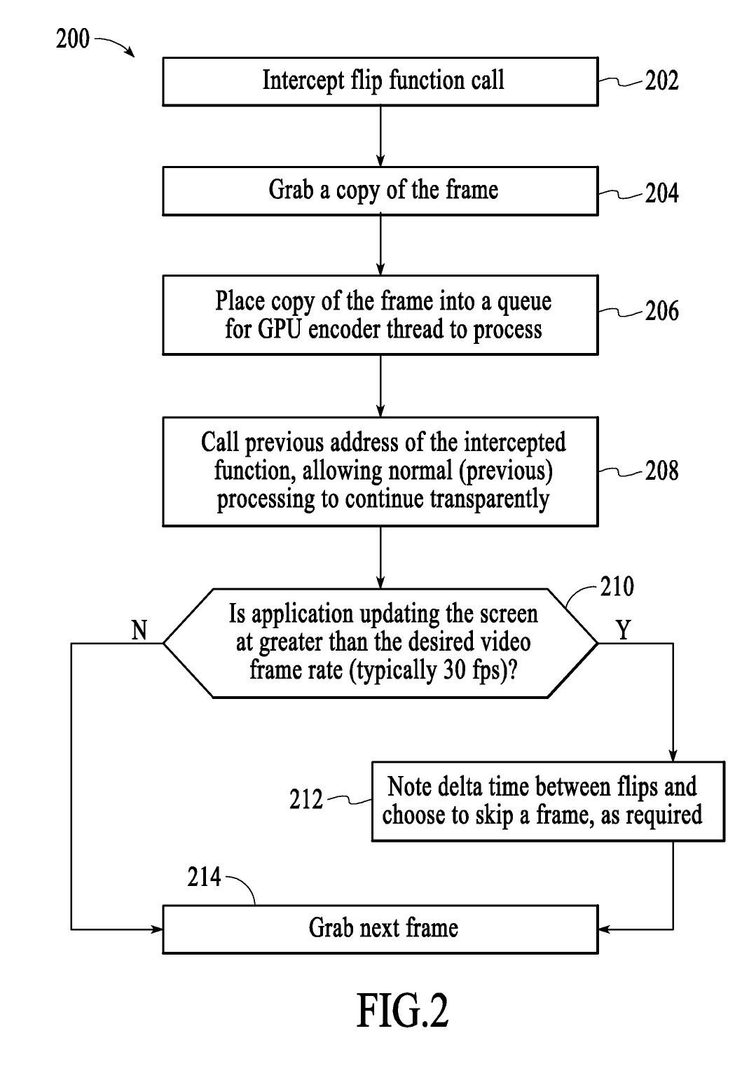

FIG. 2 is a flow diagram of a process 200 for capturing video data to be streamed according to an embodiment. At 202 a flip call is intercepted. A copy of the current frame is grabbed at 204. The copy is placed into a queue for a GPU encoder thread to process at 206. The frame would normally be processed by a CPU. Then, the previous address of the intercepted function is called at 208, thus allowing normal processing to continue transparently to the CPU and the application supplying the video data.

At 210 it is determined whether the application supplying the video data is updating the screen at greater than the desired video frame rate. If the application is updating the screen at greater than the desired video frame rate, a delta in the time between flips is noted and frames can be chosen to be skipped as required at 212. Then the next frame is grabbed at 214. If the application is not updating the screen at greater than the desired video frame rate, the next frame is grabbed at 214 without skipping any frames.

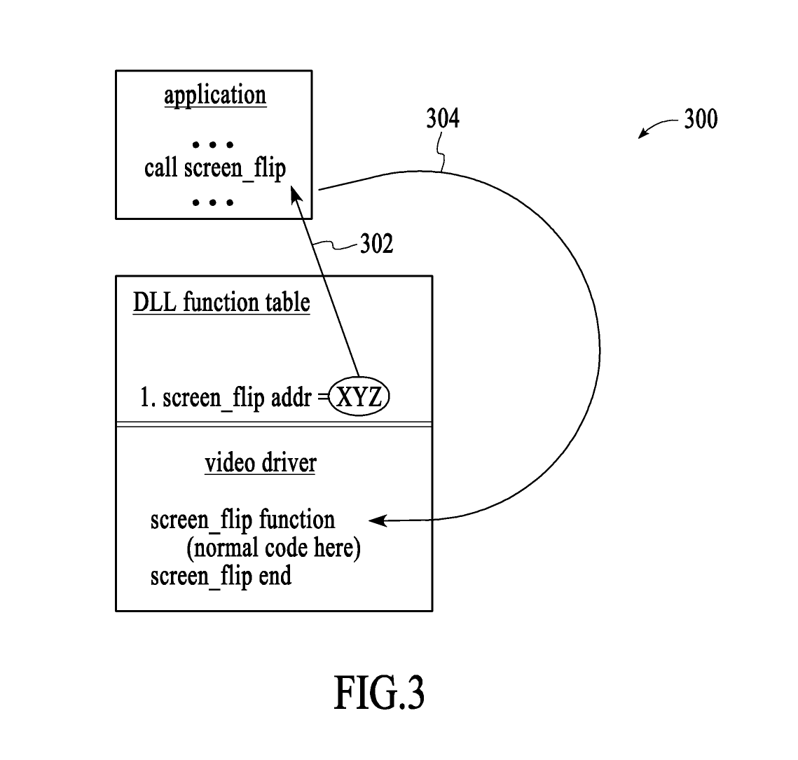

FIG. 3 is a block diagram illustrating code flow 300 before the intercepting code has been installed or substituted for the normal code. Normal dynamic linking as shown by arrow 302 causes the address of the screen flip (shown as XYZ) to be inserted into the application's call instruction. This causes the application to make a call to screen-flip, as shown by arrow 304.

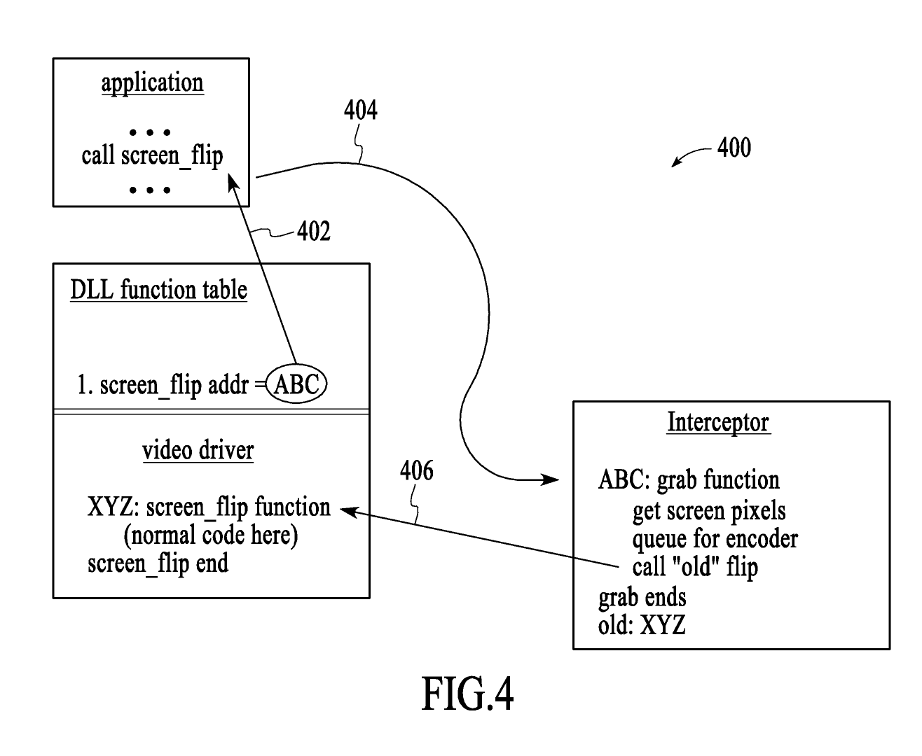

FIG. 4 is a block diagram illustrating code flow 400 after the intercepting code has been installed or substituted for the normal code. Before starting, the XYZ address is replace with the new substitute address of ABC in the DLL function table and the XYZ address is saved as the old address (not shown).

After interception, the application calls the substitute grab function as shown by arrow 404. The substitute grab function is executed, including getting screen pixels, queueing for the encoder and calling the original or “old” flip function, as shown by arrow 406.

Embodiments of the invention provide many benefits including lower cost video capture and streaming, and new capabilities. New capabilities include easy capture and play of 3D games for the purpose of demonstrations, annotation, and social sharing such as sharing of a 3D game to a handheld device. New capabilities also include the capability of playing a game on a cable TV head-end machine or mobile device (e.g., mobile phone) while the game is displayed on a (remote) TV set via a video decoder in a less expensive, existing set top box. In this scenario, application (e.g., game) inputs are transmitted from the player's device (e.g., set top box, handheld device, etc.) to the head-end system (e.g., head end cable server, mobile telephone or game operator). Responsive to these received inputs, for example character movement inputs for a game application, the head-end system executes the application and generates the video display. From the application output an encoded video stream is generated and transmitted to the remote device for decoding and display by the remote device.

There are various uses for the method and system described. These include playing new high-end games as in the scenario as described above using an older or relatively unsophisticated device (e.g., game console, handheld device or the like) that does not support new features. This may entice the consumer to upgrade to a newer console or, alternatively, cause the player to pay for the ability to play newer games on older remote devices. In a similar scenario, video games can be played for a fee without actually delivering the game to the consumer's console.

In yet another scenario, the game play can be remotely delivered in a local tournament to all local spectators and/or participants via WiFi or cell phone. This can be for any complex rendered video of a sporting event, etc. One advantage of this compared to a pure video feed is that any program or group of programs can be composited to the screen and need not be part of a required package.

Embodiments described can be for use on a PC for remoting the desktop for technical support. This feature exists today in another form, but methods described herein allow more types of screen data to be used.

Note that more than one encoder instance can be applied at a time so that one video stream can be a high definition (HD) stream while another one can be for a lower resolution display, such as for a cell phone or the like.

Aspects of the embodiments described above may be implemented as functionality programmed into any of a variety of circuitry, including but not limited to programmable logic devices (PLDs), such as field programmable gate arrays (FPGAs), programmable array logic (PAL) devices, electrically programmable logic and memory devices, and standard cell-based devices, as well as application specific integrated circuits (ASICs) and fully custom integrated circuits. Some other possibilities for implementing aspects of the embodiments include microcontrollers with memory (such as electronically erasable programmable read only memory (EEPROM), Flash memory, etc.), embedded microprocessors, firmware, software, etc. Furthermore, aspects of the embodiments may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (MOSFET) technologies such as complementary metal-oxide semiconductor (CMOS), bipolar technologies such as emitter-coupled logic (ECL), polymer technologies (e.g., silicon-conjugated polymer and metal-conjugated polymer-metal structures), mixed analog and digital, etc.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number, respectively. Additionally, the words “herein,” “hereunder,” “above,” “below,” and words of similar import, when used in this application, refer to this application as a whole and not to any particular portions of this application. When the word “or” is used in reference to a list of two or more items, that word covers all of the following interpretations of the word, any of the items in the list, all of the items in the list, and any combination of the items in the list.

The above description of illustrated embodiments of the method and system is not intended to be exhaustive or to limit the invention to the precise forms disclosed. While specific embodiments of, and examples for, the method and system are described herein for illustrative purposes, various equivalent modifications are possible within the scope of the invention, as those skilled in the relevant art will recognize. The teachings of the disclosure provided herein can be applied to other systems, not only for systems including graphics processing or video processing, as described above. The various operations described may be performed in a very wide variety of architectures and distributed differently than described. In addition, though many configurations are described herein, none are intended to be limiting or exclusive.

In other embodiments, some or all of the hardware and software capability described herein may exist in a printer, a camera, television, a digital versatile disc (DVD) player, a DVR or PVR, a handheld device, a mobile telephone or some other device. The elements and acts of the various embodiments described above can be combined to provide further embodiments. These and other changes can be made to the method and system in light of the above detailed description.

In general, in the following claims, the terms used should not be construed to limit the method and system to the specific embodiments disclosed in the specification and the claims, but should be construed to include any processing systems and methods that operate under the claims. Accordingly, the method and system is not limited by the disclosure, but instead the scope of the method and system is to be determined entirely by the claims.

While certain aspects of the method and system are presented below in certain claim forms, the inventors contemplate the various aspects of the method and system in any number of claim forms. For example, while only one aspect of the method and system may be recited as embodied in computer-readable medium, other aspects may likewise be embodied in computer-readable medium. Such computer readable media may store instructions that are to be executed by a computing device (e.g., personal computer, personal digital assistant, PVR, mobile device or the like) or may be instructions (such as, for example, Verilog or a hardware description language) that when executed are designed to create a device (GPU, ASIC, or the like) or software application that when operated performs aspects described above. Accordingly, the inventors reserve the right to add additional claims after filing the application to pursue such additional claim forms for other aspects of the method and system.

What is claimed is:

1. A video data capture method comprising:
intercepting a call to flip from a first buffer to a second buffer;
placing a copy of a current frame stored in the first buffer in a queue for encoding; and
calling a previous address of the intercepted call such that previous processing continues.

2. The method of claim 1, further comprising:
determining whether updating of the buffers is occurring at greater than a desired frame rate; and
if the updating is occurring at a greater than a desired frame rate, noting a delta time between flips and skipping frames as required.

3. The method of claim 1, further comprising replacing an address of the call with a substitute address.

4. The method of claim 3, further comprising:
placing the substitute address in a dynamic link library (DLL) function table; and
saving the address of the call.

5. The method of claim 1, wherein the call is from an application.

6. The method of claim 1, wherein encoding comprises encoding by a GPU the frame data stored in at least one of the buffers and wherein the method further comprises streaming the encoded frames to at least one destination via a network.

7. A video data capture system, comprising:
at least one video data source comprising a central processing unit (CPU) running a video application;
at least one graphics processing unit (GPU) coupled to the video data source for receiving video frames, the at least one GPU configurable to,
intercept a flip function call comprising a call by the video application to flip frames between a first and second buffer;
grab a copy of the current frame that would normally be processed by a central processing unit (CPU); and
place the copy in a queue for processing by a graphics processing unit (GPU), wherein processing by the GPU is significantly faster than processing by the CPU.

8. The system of claim 7, further comprising calling a previous address of the intercepted function such that previous processing continues.

9. The method of claim 7, wherein the at least one GPU is further configurable to:
determine whether the application is updating a screen displaying the video data at greater than a desired frame rate; and
if the application is updating the screen at greater than a desired frame rate, note a delta time between frame flips and skipping frames as required.

10. The method of claim 7, further comprising replacing an address of the flip function call with a substitute address.

11. The method of claim 10, further comprising:
placing the substitute address in a dynamic link library (DLL) function table; and
saving the address of the flip function call.

12. The method of claim 7, wherein the application is a video game.

13. The method of claim 7, wherein processing by the GPU comprises encoding the video data and wherein the method further comprises streaming the encoded video data to at least one destination via a network.

14. A computer readable medium having instructions stored thereon that, when executed in a system comprising a video data source, cause a video data capture method to be executed, the method comprising:
intercepting a call to flip from a first buffer to a second buffer;
placing a copy of a current frame stored in the first buffer in a queue for encoding; and
calling a previous address of the intercepted call such that previous processing continues.

15. The computer readable medium of claim 14, wherein the method further comprises:
determining whether updating of the buffers is occurring at greater than a desired frame rate; and
if the updating is occurring at a greater than a desired frame rate, noting a delta time between flips and skipping frames as required.

16. A method of viewing an application at a device comprising:
transmitting to application inputs to an application server remote from the device;
receiving an encoded video data stream at the device, said encoded video data stream encoding application output, said application output responsive to the transmitted application inputs; and
decoding said received encoded video data stream.

17. The method of claim 16 further comprising displaying said decoded video data stream.

18. The method of claim 16 wherein said device comprises a mobile device.

19. The method of claim 16 wherein said application comprises a game application and wherein said application inputs comprise game application inputs and wherein said application output comprises frame data.
